(19) United States
(12) Patent Application Publication
(10) Pub. No.: US 2019/0346247 A1
(43) Pub. Date: Nov. 14, 2019

(54) ALIGNMENT TOOL FOR POSITIONING FRAMING MEMBERS IN BUILDING FRAME

(71) Applicant: William E. Kracht,, IV, New Port Richey, FL (US)

(72) Inventor: William E. Kracht,, IV, New Port Richey, FL (US)

(21) Appl. No.: 16/405,574

(22) Filed: May 7, 2019

Related U.S. Application Data
(60) Provisional application No. 62/670,236, filed on May 11, 2018.

(51) Int. Cl. G01B 5/16; B25B 27/14; B23K 37/04

(52) U.S. Cl. CPC G01B 5/16; B23K 37/0435; B25B 27/14

(57) ABSTRACT

An alignment tool for use in building frame construction to position adjacent first and second framing members includes a first clamp assembly configured to releasably grip the first framing member. A second clamp assembly is connected to and spaced apart from the first clamp assembly. The second clamp assembly is configured to releasably grip the second framing member. The first and second clamp assemblies are configured to align and position the first and second framing members with respect to one another when the first and second clamp assemblies grip the first and second framing members.

### CROSS-REFERENCE TO RELATED APPLICATION

This application claims the benefit of U.S. Provisional Application No. 62/670,236, filed May 11, 2018, the entire contents of which are hereby incorporated by reference.

### FIELD OF THE DISCLOSURE

The present disclosure generally relates to a tool used to measure, position, align and/or straighten framing members, such as studs, joists or rafters, used to construct a building frame in building frame construction, such as wood or metal framed homes.

### BACKGROUND OF THE DISCLOSURE

Measurement tools (e.g., rulers, tape measurers, etc.) allow a construction worker to mark the locations of wall studs or ceiling joists and rafters in new construction. This allows the workers to place the studs or joists in correct positions for permanent attachment.

### SUMMARY OF THE DISCLOSURE

In one aspect, an alignment tool includes two clamp assemblies, each configured to clamp onto a framing member. The clamp assemblies are arranged such that they position an unattached framing member in the building frame when one clamp assembly grips a framing member already fixed in the building frame and the other clamp assembly grips the unattached framing member. Using the alignment tools of the present disclosure provides a quick and easy way to properly place successive framing members used in building frame construction and ensures that the framing members are square with the building frame footer and header.

In another aspect, an alignment tool for use in building frame construction to position adjacent first and second framing members comprises a first clamp assembly configured to releasably grip the first framing member. A second clamp assembly is connected to and spaced apart from the first clamp assembly. The second clamp assembly is configured to releasably grip the second framing member. The first and second clamp assemblies are configured to align and position the first and second framing members with respect to one another when the first and second clamp assemblies grip the first and second framing members, respectively.

In another aspect, a method of positioning adjacent first and second framing members in building frame construction with respect to one another comprises gripping the first framing member with a first clamp assembly of an alignment tool and gripping the second framing member with a second clamp assembly of the alignment tool. The first and second framing members are positioned with respect to one another when the first clamp assembly grips the first framing member and the second clamp assembly grips the second framing member.

In yet another aspect, an alignment tool for use in building frame construction to position adjacent first and second framing members comprises a rigid elongate body having opposite first and second ends. An arm is connected to the rigid elongate body adjacent the first end of the rigid elongate body. The arm is configured to engage an outer side of the first framing member. A clamp assembly is connected to the rigid elongate body adjacent the second end of the rigid elongate body. The clamp assembly has a first jaw member and a second jaw member. The clamp assembly is configured to releasably grip the second framing member between the first and second jaw members. The arm and the clamp assembly are configured to align and position the first and second framing members with respect to one another when the arm engages the outer side of the first framing member and the clamp assembly grips the second framing member.

Other objects and features will be in part apparent and in part pointed out hereinafter.

### BRIEF DESCRIPTION OF THE DRAWINGS

FIG. 1 is a perspective of an alignment tool according to one embodiment of the present disclosure with the alignment tool in an open position;

FIG. 2 is a perspective of the alignment tool in a closed position and secured to, aligning, spacing apart and positioning adjacent framing members;

FIG. 3 is a rear view of FIG. 2;

FIG. 4 is an exploded perspective of the alignment tool;

FIG. 5 is a perspective of an alignment tool according to another embodiment of the present disclosure;

FIG. 6 is a perspective of an alignment tool according to another embodiment of the present disclosure; and

FIG. 7 is a perspective of the alignment tool of FIG. 6 secured to, aligning, spacing apart and positioning adjacent framing members.

Corresponding reference characters indicate corresponding parts throughout the drawings.

### DETAILED DESCRIPTION OF THE DISCLOSURE

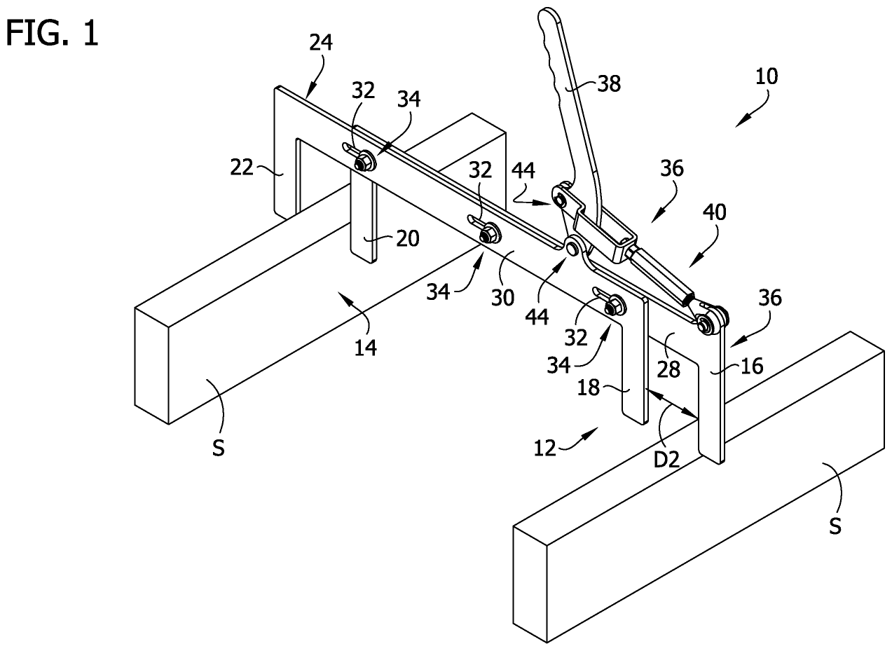

Referring to FIG. 1, an alignment tool according to one embodiment of the present disclosure is generally shown at 10. The alignment tool 10 is configured to align, position, and space apart framing members S used in building frame construction. The alignment tool is also configured to ensure the framing members S are placed and fastened in the correct location and are square with the walls. As discussed in more detail below, the alignment tool 10 is configured to engage adjacent or successive framing members S to orient and arrange the framing members so that the framing members may be quickly and easily assembled together to form a building frame. In this description it is understood that the term “framing member” can refer to any structural component used in building frame construction such as, but not limited to, a joist, a stud, a beam, a strut, a rafter and a girder. It is also understood the alignment tool of the present disclosure can be used with in any type of building frame construction, such as wood frame construction and metal frame construction.

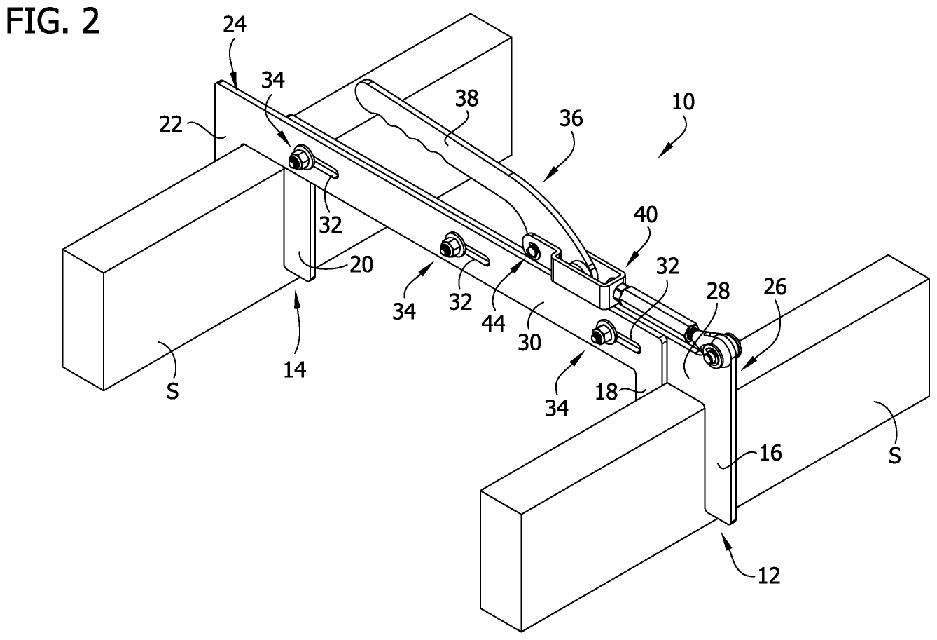

Referring to FIGS. 1-4, the illustrated alignment tool 10 includes first and second clamp assemblies 12 and 14, respectively. The first and second clamp assemblies 12, 14 are each configured to releasably grip or clamp onto a framing member S. The first clamp assembly 12 includes two jaw members 16 and 18, respectively, and the second clamp assembly 14 includes two jaw members 20 and 22, respectively. As shown in FIGS. 1 and 2, the jaw members 16, 18 of the first clamp assembly 12 are configured to releasably engage and grip one framing member S and jaw members 20, 22 of the second clamp assembly 14 are configured to releasably engage and grip another framing member S. The jaw members 16, 18, 20, 22 are sized and shaped to correspond to the size and shape of the framing members S they grip. In the illustrated embodiment, the jaw members 16, 18, 20, 22 are sized and shaped to grip dimensioned lumber, such as 2 in×4 in (5 cm×10 cm) and/or 2 in×6 in (5 cm×15 cm) studs commonly used in wood frame construction. In one embodiment, the jaw members 16, 18, 20, 22 have other shapes and arrangements to correspond to other types of framing members.

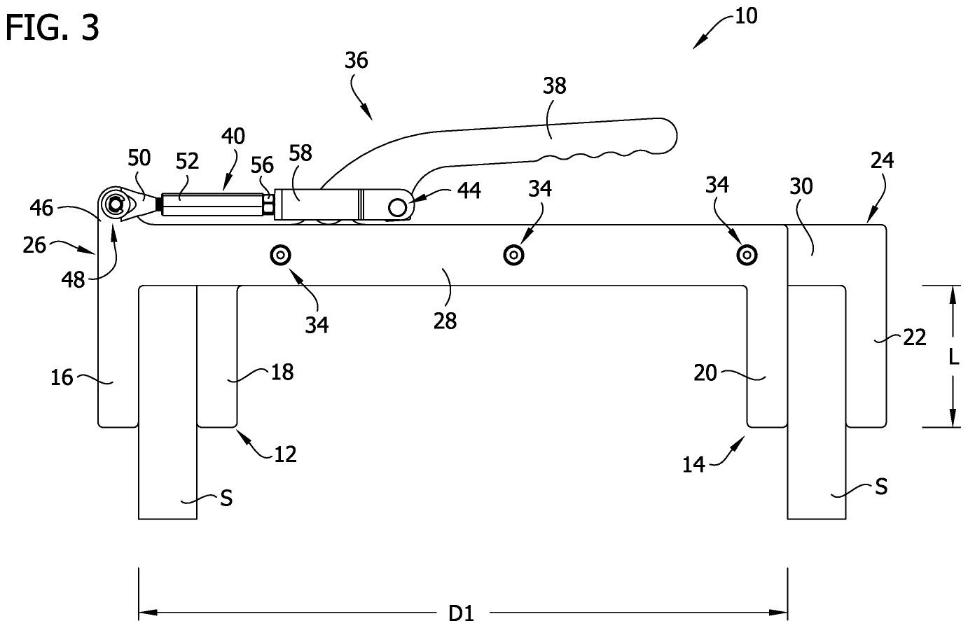

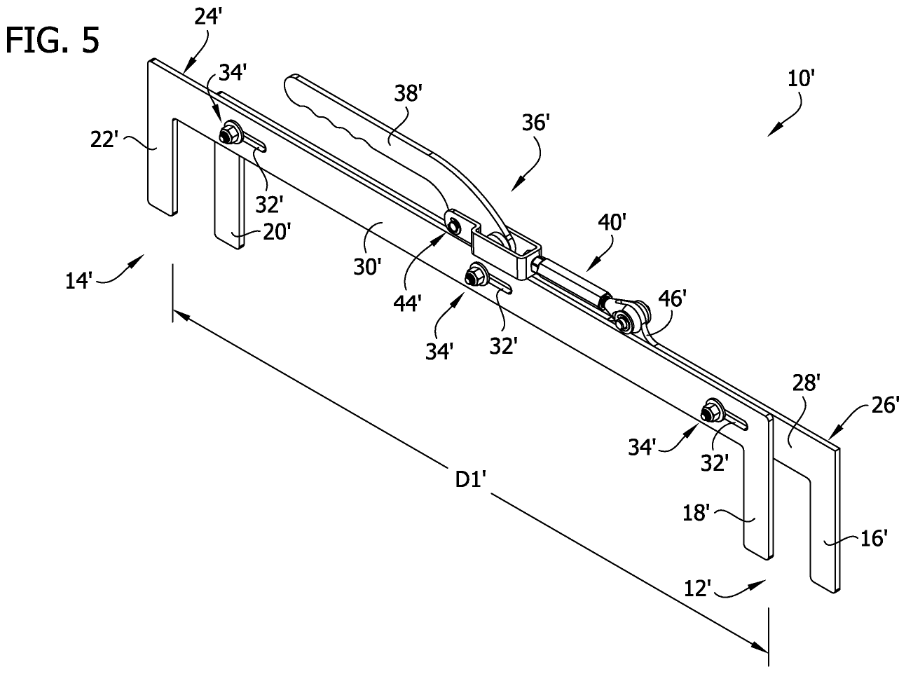

The first and second clamp assemblies 12, 14 are spaced apart by a framing distance D1 (FIG. 3) which corresponds to the distance the alignment tool 10 will separate (e.g., position) adjacent framing members S (commonly referred to as “on center” as known in the art). In the illustrated embodiment, the framing distance D1 is about 16 inches (41 cm), which is a typical spacing dimension used in building frame construction. In other embodiments, the framing distance between the first and second clamp assemblies may be of other dimensions to position adjacent framing members S at other distances as required by a contractor or builder. For example, the first and second clamp assemblies can be spaced apart such that adjacent framing members S are separated by a framing distance that is about 24 inches (61 cm) on center. An example of such an alignment tool is generally indicated at 10′ in FIG. 5, with corresponding parts given corresponding reference numbers, plus a prime symbol. Further still, in one embodiment, the first and second clamp assemblies may be movable relative to one another such that the framing distance D1 of the alignment tool 10 is adjustable to accommodate a variety of different framing member spacings. For example, in one embodiment, the spacing between the first and second clamp assemblies 12, 14 is adjustable between the inclusive range of about 16 inches (41 cm) to about 24 inches (61 cm). It is appreciated that the framing distance D1 is generally parallel to a longitudinal axis of the alignment tool 10.

In the illustrated embodiment, the alignment tool 10 includes a stationary bracket 24 and a movable bracket 26 (e.g., first and second brackets). The jaw members 16, 20 of the first and second clamp assemblies 12, 14, respectively, are a part of the movable bracket 26 and the jaw members 18, 22 of the first and second clamp assemblies, respectively, are a part of the stationary bracket 24. In other words, together, the stationary and movable brackets 14, 16 define the clamp assemblies 12, 14. Jaw members 16, 20 are positioned at opposite ends of the movable bracket 26 and jaw members 18, 22 are positioned at opposite ends of the stationary bracket 24. Both the stationary bracket 24 and movable bracket 26 include an intermediate member, 30 and 28, respectively, that spans between and interconnects the jaw members 16, 18, 20, 22 at each end of the stationary and movable brackets. Thus, jaw member 16 is fixed to jaw member 20 and jaw member 18 is fixed to jaw member 22. In the illustrated embodiment, the jaw members 16, 18, 20, 22 are portions of the stationary or movable brackets 24, 26 that extend away from (e.g., perpendicular to) their respective intermediate member 28, 30. In the preferred embodiment, each jaw member, 16, 18, 20, 22 extends from their respective intermediate member 28, 30 by a jaw length L (FIG. 3) that corresponds to the framing member S height (or a little less) so that each jaw member can adequately grip the framing member. Preferably, the jaw length L is greater than half the height of the framing member S. Jaw length L can vary depending on the height (e.g., size) of the framing member S being used. For example, for 2″×4″ studs, the jaw length L would be approximately 3.5 inches (9 cm) and for a 2 in×6 in (5 cm×15 cm) stud, the jaw length would be approximately 5.5 inches (14 cm). Other dimensions of jaw length L are within the scope of the present disclosure.

Both the jaw members 16, 20 of the movable bracket 26 and the jaw members 18, 22 of the stationary bracket 24 are space apart by a distance equal to the framing distance D1. Because both the jaw members 16, 20 of the movable bracket 26 and the jaw members 18, 22 of the stationary bracket 24 are space apart by the same distance, the illustrated alignment tool 10 is configured to receive the same size framing member S in each of the first and second clamp assemblies 12, 14. However, in one embodiment the distance between the jaw members 16, 20 of the movable bracket 26 and the jaw members 18, 22 of the stationary bracket 24 may be spaced apart by different distances so that the alignment tool 10 can position adjacent framing members S of different sizes. It is understood the jaw members 16, 18, 20, 22 and first and second clamp assemblies 12, 14 may have other constructions and configurations that are within the scope of the present disclosure.

As described in more detail below, the movable bracket 26 is movable with respect to stationary bracket 24 to move the jaw members 16, 20 (broadly, the first and second clamp assemblies 12, 14) between a closed position (FIG. 2), where the jaw members 16, 18 of the first clamp assembly engage and grip one framing member S and jaw members 20, 22 of the second clamp assembly engage and grip another framing member S, and an open position (FIG. 1), where the jaw members 16, 18 of the first clamp assembly do not grip framing member S and jaw members 20, 22 of the second clamp assembly do not grip the other framing member S. In other words, the clamp assemblies 12, 14 grip the framing members S in the closed position and release the framing members in the open position. In the open position, the jaw members 16, 18 of the first clamp assembly 12 and the jaw members 20, 22 of the second clamp assembly 14 are spaced apart by a jaw opening distance D2 (FIG. 1) that is greater than a width of the framing member S so that a framing member can be inserted between the jaw members of each respective clamp assembly. In the preferred embodiment, the jaw opening distance D2 is about 2 inches (5 cm) so that the alignment tool 10 can be used to position standard 2 in×4 in (5 cm×10 cm) and 2 in×6 in (5 cm×15 cm) studs (it is appreciated by one skilled in the art that the actual size of dimensioned lumber is less than the measurement the lumber is called by). In other embodiments, the jaw opening distance D2 between jaw members 16, 18, 20, 22 of each clamp assembly 12, 14 may be of other dimensions to accommodate framing members of other sizes.

Still referring to FIGS. 1 and 3, the movable bracket 26 is movably connected to the stationary bracket 24 such that the movable bracket can move relative to the stationary bracket (e.g., the stationary bracket is stationary relative to the movable bracket and provides a point of reference for the movement of the movable bracket). In other words the brackets 24, 26 are movable coupled to one another such that the brackets are movable relative to one another. In the illustrated embodiment, the movable bracket 26 is longitudinally slidable or moveable (e.g., the movable bracket moves in a direction that is generally parallel to a longitudinal axis extending between the ends of the movable bracket and the longitudinal axis of the alignment tool 10) relative to the stationary bracket 24. At least two slots 32 positioned on the intermediate member 30 of the stationary bracket 24 receive fastener assemblies 34 that extend through holes 33 in the intermediate member 28 of the movable bracket 26 to movably connect the movable bracket to the stationary bracket. The fastener assemblies 34 each include a bolt, a nut and at least one washer. The fastener assemblies 34 are tightened (e.g., the nut is threaded onto the bolt) to secure the stationary and movable brackets 24, 26 together but not so tight as to prevent the movable bracket from moving or sliding with respect to the stationary bracket. It is appreciated the length of the slots 32 corresponds to the distance the movable bracket 26 can move relative to the stationary bracket 24. Accordingly, the fastener assemblies 34 are generally disposed at one end of the slot 32 in the open position and the fastener assemblies are disposed at the other end of the slot in the closed position. It is understood slots 32 and holes 33 can each be included on either bracket 24, 26. Other ways of movably connecting the stationary and movable brackets 24, 26 are within the scope of the present disclosure.

The stationary and movable brackets 24, 26 are each made from a single piece of material, a piece of sheet metal cut to shape or other material. The sheet metal can be of any composition and thickness (e.g., gauge) but in the preferred embodiment, the brackets 24, 26 are made from a high strength steel with a thickness between the inclusive range of ⅛ to ⅜ inches (3 to 10 mm). The particular thickness of the sheet metal used to form brackets 24, 26 can depend on the size of the framing members S being positioned. For example, if the alignment tool 10 is used to position smaller sized framing members S, such as 2 in×4 in (5 cm×10 cm) studs, a smaller gauge of sheet metal may be used to reduce the cost of the alignment tool. Conversely, if the alignment tool 10 is used to position larger sized framing members S, such as 2 in×6 in (5 cm×15 cm) studs or ceiling joists (which are generally large), a larger gauge of sheet metal, which is stronger and more rigid, may be preferred. In addition to high strength steel, the components of the alignment tool 10 can be made from any suitable material, such as, but not limited to, aluminum, molecular plastics, carbon fiber or high strength molded plastics reinforced with glass fibers or carbon fiber materials.

Still referring to FIGS. 1-4, the alignment tool 10 includes a prime mover 36 operatively connected to and configured to move the first and second clamp assemblies 12, 14 between the open and closed positions. In particular, the prime mover 36 is operatively connected to one of the stationary and movable brackets 24, 26 to move one of the brackets relative to the other bracket to move the jaw members 16, 18, 20, 22 of the clamp assemblies 12, 14 relative to one another to releasably grip the framing members S. More specifically, the prime mover 36 is operatively connected to the movable bracket 26 and, therefore, the jaw member 16 of the first clamp assembly 12 and the jaw member 20 of the second clamp assembly 14 (broadly, one jaw member of each of the first and second clamp assemblies) such that the prime mover can move jaw members 16, 20 to releasably grip the framing members S. In this manner, the prime mover 36 can open and close the first and second clamp assemblies 12, 14 simultaneously. In other words, the prime mover 36 is configured to move one of the jaw members 16, 18, 20, 22 of the clamp assemblies 10, 12 at the same time. Broadly, the prime mover 36 is operatively connected to one of the jaw members 16, 18, 20, 22 of each clamp assembly 12, 14 to move the respective jaw members to releasably grip the framing members S.

The prime mover 32 is preferably coupled to both the brackets 24, 26 in order to move the movable bracket relative to the stationary bracket. In the illustrated embodiment, the prime mover 36 includes a lever 38 and a linkage assembly 40 connected to the lever. The lever 38 is connected to the stationary bracket 24 at a first location on the lever and the linkage assembly 40 at a second location on the lever, spaced part from the first location. The lever 38 is connected to a lever mounting portion 42 of the stationary bracket 24 by a pin assembly 44, including a pin and a snap ring, extending through aligned openings in the lever and lever mounting portion. Similarly, the lever 38 is connected to the linkage assembly 40 by another pin assembly 44 extending through aligned openings in the lever and linkage assembly. The lever 38 is configured to pivot about the pin assembly 44 (e.g., the lever is pivotably connected to the stationary bracket 24).

The linkage assembly 40 is connected at one end to the lever 38 and the movable bracket 26 at the other end. The linkage assembly 40 is connected to a linkage mounting portion 46 of the movable bracket 26 by a pin assembly 48, including a pin, two washers and two snap rings, extending through aligned openings in the linkage assembly and the linkage mounting portion. The linkage mounting portion 46 is longitudinally spaced apart from the lever mounting portion 42. In the illustrated embodiment, the lever mounting portion 42 and linkage mounting portion 46 extend upward from intermediate members 30, 28, respectively. The lever mounting portion 42 and linkage mounting portion 46 can be disposed at any position on the brackets 26, 24. The linkage assembly 40 spans between and interconnects the lever 38 to the linkage mounting portion 46 of the movable bracket 26. As is apparent, the linkage assembly 40 is pivotably connected to both the lever 38 and the movable bracket 26. The linkage assembly 40 includes a threaded clevis rod 50, an internally threaded turnbuckle 52 threadably connected to the clevis rod, a bolt 54 threadably connected to the turnbuckle, a nut 56 threaded on the bolt and a lever bracket 58 through which the bolt extends. The clevis rod 50 is connected to the linkage mounting portion 46 of the movably bracket 26 and the lever bracket 58 is attached to the lever 38. As shown in FIG. 2, the lever bracket 58 is generally U-shaped and defines a space that receives a portion of the lever 38 and the lever mounting portion 42. Other configurations and constructions of the linkage assembly are within the scope of the present disclosure.

The lever 38 is configured to be manually actuated to move the clamp assemblies 12, 14 between the open and closed positions. The lever 38 pivots about the pin assembly 44 connecting the lever to the lever mounting portion 42 of the stationary bracket 24 (e.g., the first location) to move the clamp assemblies 12, 14 between the open and closed positions. To move the clamp assemblies 12, 14 to the open position (FIG. 1), the user lifts or rotates the lever in a clockwise (e.g., first) direction, when the alignment tool 10 is in the orientation shown in FIG. 2. As the lever 38 is rotated in the clockwise direction, the linkage assembly 40 moves (e.g., pushes) the movable bracket 26 in a first longitudinal direction relative to the stationary bracket 24 to open the clamp assemblies 12, 14 (FIG. 1). The lever 38 is rotated until the fastener assemblies 34 engage an end of the slots 32 in the stationary bracket 24. To move the clamp assemblies 12, 14 to the closed position (FIG. 2), the user lowers or rotates the lever in a counter-clockwise (e.g., second) direction, when the alignment tool 10 is in the orientation shown in FIG. 1. As the lever 38 is rotated in the counter-clockwise direction, the linkage assembly 40 moves (e.g., pulls) the movable bracket 26 in a second longitudinal direction, generally opposite the first longitudinal direction, relative to the stationary bracket 24 to close the clamp assemblies 12, 14 (FIG. 2). The lever 38 is rotated until the clamp assemblies 12, 14 grip the framing members S. Thus, the prime mover 36 moves the clamp assemblies 12, 14 between the open and closed positions at the same time (e.g., simultaneously). It is understood that other methods of moving the movable bracket 26 relative to the stationary bracket 24 (broadly, other methods of opening and closing the clamp assemblies 12, 14) are within the scope of the present disclosure. For example, a linear actuator or a gear mechanism, such as a rack and pinion, may be used to move the movable bracket.

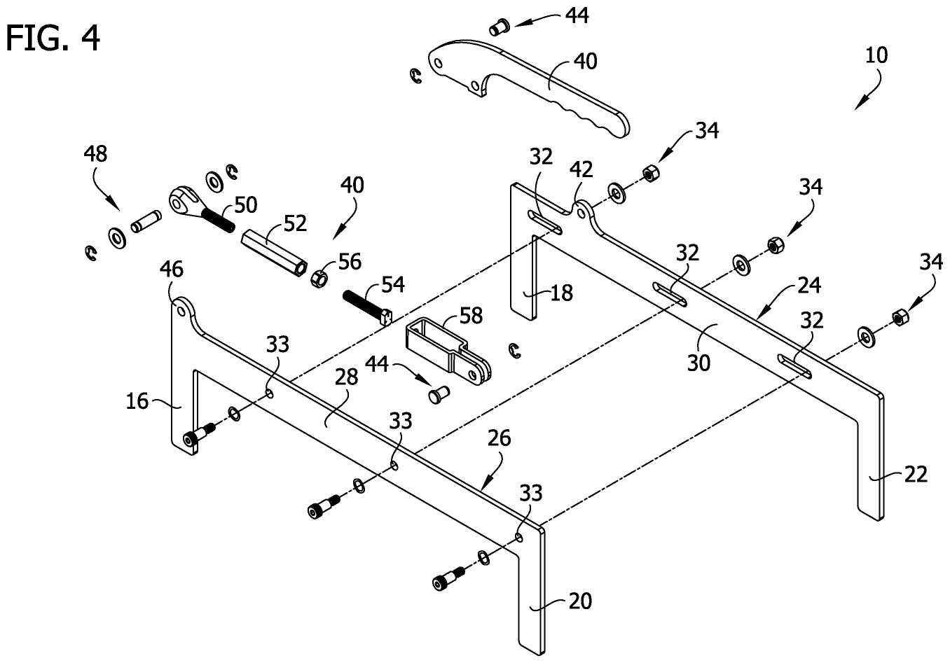

Referring to FIGS. 1 and 2, in operation, the alignment tool 10 grips adjacent framing members S to properly position, align, and straighten the framing members with respect to one another and the overall building frame of which the framing member are apart. Preferably, during use, one of the framing members S (e.g., a reference framing member) the alignment tool 10 is mounted on and grips is already fixed to the building frame. With the clamp assemblies 12, 14 in the open position, the construction worker (broadly, a user or operator) positions the alignment tool 10 such that a first framing member S is received in the first clamp assembly 12 and a second, adjacent framing member S is received in the second clamp assembly 14. In particular, each framing member S is positioned between the jaw members 16, 18, 20, 22 of each clamp assembly 12, 14. As shown in FIG. 4, when inserted into one of the clamp assemblies 12, 14, the top of the framing member S engages a portion of the respective intermediate member 28, 30, such that the framing member is received and positioned in the U-shaped space defined by the opposite jaw members 16, 18, 20, 22 of the clamp assembly and the respective intermediate member. Once the framing members S are inserted into the clamp assemblies 12, 14, the clamp assemblies are moved to the closed position to grip and position the loose (e.g., unattached) framing member S in the building frame. It is appreciated that the loose and reference framing members S can be received in either of the clamp assemblies 12, 14. The construction worker operates the prime mover 36 to move the movable bracket 26 relative to the stationary bracket 24 and close the clamp assemblies 12, 14. In the illustrated embodiment, as the clamp assemblies 12, 14 are closed by the prime mover 36, the clamp assemblies (specifically, the jaw members 16, 20 on the movable bracket 26) engage the loose and reference framing members to guide (e.g., move) the loose framing member into position. In the closed position, opposing edge margins of the jaw members 16, 18 of the clamp assembly 12 and the lower edge margin of the intermediate member 28 engage one of the framing members S (e.g., the sides and top surfaces of the framing member) and opposing edge margins of the jaw members 20, 22 of the clamp assembly 14 and the lower edge margin of the intermediate member 30 engage the other framing member (e.g., the sides and top surfaces of the framing member).

In the closed position, opposite jaw members 16, 18 of the first clamp assembly 12 engage and hold the opposite sides of one framing member S and opposite jaw members 20, 22 of the second clamp assembly 14 engage and hold the opposite sides of another framing member S. Preferably, the first and second clamp assemblies 12, 14 apply a sufficient amount of force to the framing members S to firmly hold the loose framing member in place. Once the clamp assemblies 12, 14 are closed, the alignment tool 10 holds the loose framing member S in position relative to the reference framing member such that the loose framing member is positioned and aligned in the building frame. In particular, the loose framing member S is generally parallel to the reference framing member, is spaced apart from the reference framing member by the desired spacing (e.g., 16 inches on center), and is generally squared up (e.g. perpendicular) with the building frame header and footer. Once the loose framing member is in position and held there by the alignment tool 10, the construction worker can fix the loose framing member to the building frame and then move the alignment tool 10 to position the next successive framing member. This process repeats until the building frame is fully assembled.

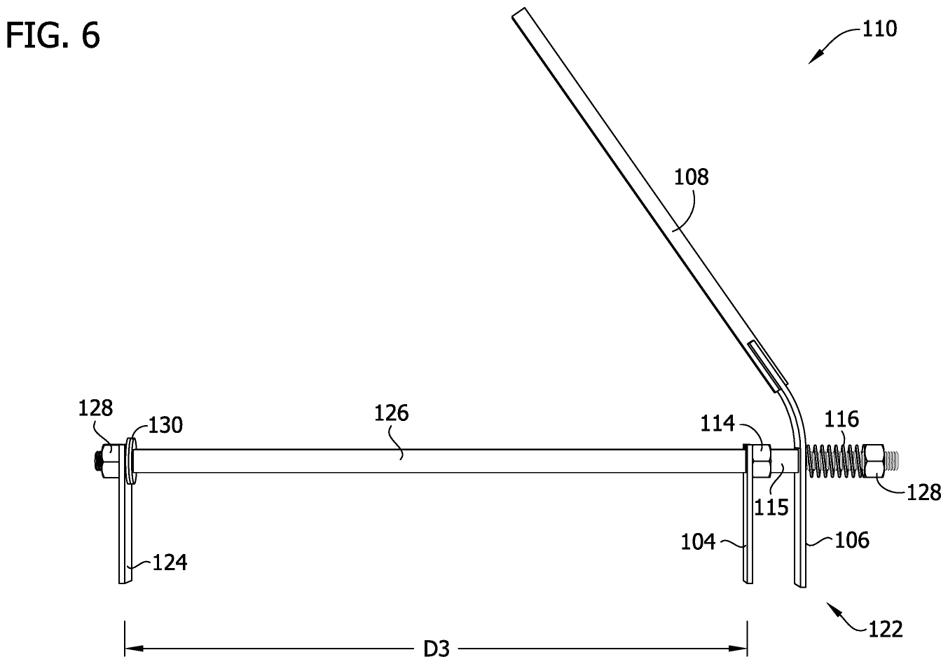

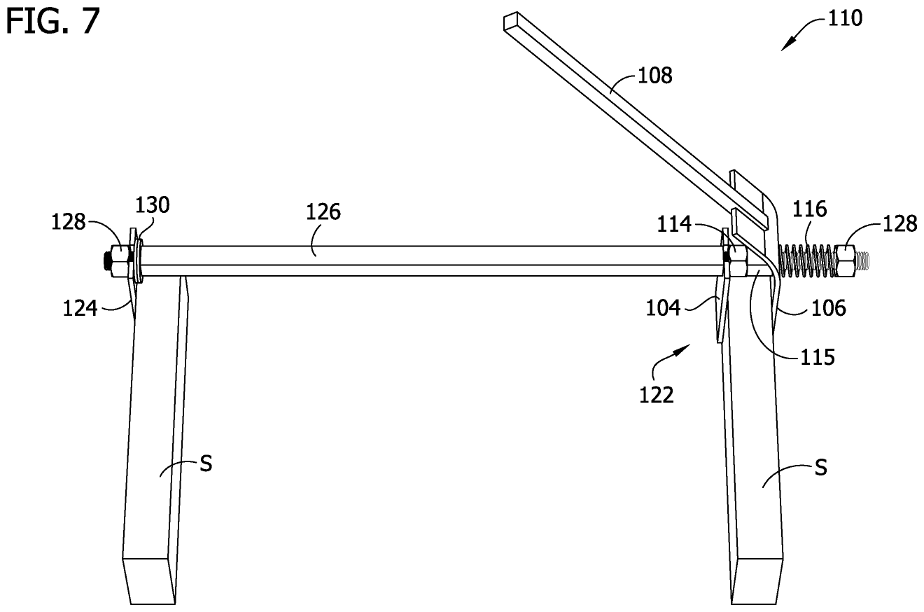

Referring to FIGS. 6 and 7, an alignment tool according to another embodiment of the present disclosure is generally shown at 110. In this embodiment, the alignment tool 110 includes a clamp assembly 122 spaced apart from an arm 124. The clamp assembly 122 and arm 124 are positioned at opposite ends of an intermediate member or body 126 of the alignment tool 110. The arm 124 is configured to engage one framing member S (such as the fixed framing member). In the illustrated embodiment, the arm 124 is a rigid plate secured to one end of the intermediate member 126 configured to engage the side (i.e., outer side) of the framing member S. The end of the intermediate member 126 is threaded and inserted through a hole (not shown) in the arm 124, the arm being secured to the intermediate member with a nut 128 and washers 130. Other manners of attaching the arm 124 to the intermediate member 126 are within the scope of the present disclosure. When the arm 124 is secured to the intermediate member 126, the arm is generally perpendicular to the intermediate member.

The clamp assembly 122 is configured to releasably grip another framing member S. The clamp assembly 122 includes jaw members 104 and 106 configured to releasably engage and grip the framing member S there-between. Jaw member 104 is similar to arm 124, and is fixed to one end of the intermediate member 126 by a nut 114. Other manners of attaching jaw member 104 to the intermediate member 126 are within the scope of the present disclosure such as by welding. When the jaw member 104 is secured to the intermediate member, the jaw member 104 is generally perpendicular to the intermediate member and parallel to the arm 124. Jaw member 106 includes a lower portion that extends below the intermediate member 126 and engages the framing member S and an upper portion extending above the intermediate member and coupled to a lever 108. In the illustrated embodiment, the upper portion of the jaw member 106 is bent or angled with respect to the lower portion. As explained in more detail below, the lever 108 is manually operated to move jaw member 106 between open and closed positions. Thus, jaw member 106 is movably attached to the intermediate member 126. The end of the intermediate member 126 is threaded (e.g., both ends of the intermediate member are threaded) and is inserted through a hole (not shown) in the jaw member 106.

Jaw member 106 is spaced apart from jaw member 104 by a spacer 115 such that the framing member S can be received between the jaw members of the clamp assembly 122. In the illustrated embodiment, the spacer 115 is inserted over the threaded end of the intermediate member 126 and is disposed between the jaw members 104, 106 such that the distance the jaw members are spaced apart is set by the spacer (e.g., the distance between the jaw members is established by the nut 114 and spacer). The spacer 115 can have a variety of lengths and configurations to space apart the jaw members 104, 106. For example, in one embodiment, the spacer 115 is fixed to the jaw member 106. A spring 116 engages the jaw member 106 and biases the jaw member against the spacer 115. The spring 116 biases the jaw member 106 in the closed position (broadly, the clamp assembly 122 in the closed position). In the illustrated embodiment, the spring 116 is a compression or coil spring wrapped around the threaded end of the intermediate member 126 with one end of the spring engaging the jaw member 106 on a side opposite the spacer 124 and the other end of the spring engaging a nut 128 threadably received on the intermediate member. Similar to the components of alignment tool 10, the jaw members 104, 106 and arm 124 of alignment tool 110 are sized and shaped to correspond to the size and shape of the framing members they engage, such as 2 in×4 in (5 cm×10 cm) and/or 2 in×6 in (5 cm×15 cm) studs commonly used in wood frame construction.

The arm 124 and clamp assembly 122 are spaced apart by a framing distance D3 (measured between the arm and jaw member 104) which corresponds to the distance the alignment tool 110 will separate (e.g., position) adjacent framing members S. In one embodiment, the framing distance D3 of the alignment tool 110 is about 16 inches (41 cm) so that adjacent framing members S are positioned 16 inches on center. In other embodiments, the framing distance between the arm 124 and clamp assembly 122 may be of other dimensions to separate adjacent framing members S at other distances. Further still, because the ends of the intermediate member 126 are threaded, in one embodiment the arm 124 can be moved relative to the clamp assembly 122 to adjust the framing distance. In this embodiment, a large portion of the intermediate member 126 between the arm 124 and clamp assembly 122 may be threaded such that the arm can be selectively positioned longitudinally along the intermediate member.

The arm 124 and jaw members 104, 106 are each made from a single piece of material, a piece of sheet metal cut to shape. The sheet metal can be of any composition and thickness (e.g., gauge) but in the preferred embodiment, the arm 124 and jaw members 104, 106 are made from a high strength steel with a thickness between the inclusive range of ⅛ to ⅜ inches (3 to 10 mm). The particular thickness of the sheet metal used to form arm 124 and jaw members 104, 106 can depend on the size of the framing members S being used to construct the building frame, as described above. In addition to high strength steel, the components of the alignment tool 110 can be made from any suitable material, such as, but not limited to, aluminum, molecular plastics, carbon fiber or high strength molded plastics reinforced with glass fibers or carbon fiber materials.

As mentioned above, the jaw member 106 of the clamp assembly 122 is movable between a closed position (FIG. 7), where the jaw members 104, 106 engage and grip one framing member S, and an open position (not shown), where the jaw members are separated by a sufficient distance such that they do not grip framing member S. In the open position, the jaw members 104, 106 of the clamp assembly 122 are spaced apart such that the framing member S can be inserted in between the jaw members. It is understood that the jaw members 104, 106 can be shape and arranged such that clamp assembly 122 can receive a framing member of generally any size. To move the clamp assembly 122 between the open and closed positions, the lever 108 is manually operated by the construction worker. To move the clamp assembly 122 (e.g., jaw member 106) to the open position, the construction worker moves the lever downward, which in turn pivots the jaw member 106 about the intermediate member 126 and moves the lower portion of the jaw member 106 away from jaw member 104. Jaw member 106 is able to pivot about the intermediate member 126 because the hole (not shown) of the jaw member the intermediate member extends through is larger than the intermediate member (e.g., the hole has a large diameter than that of the threaded end of the intermediate member). It is appreciated that the size of the hole relative to the intermediate member corresponds to the distance jaw member 106 can pivot. To move the clamp assembly 122 (e.g., jaw member 106) to the closed position, the construction worker moves the lever 108 upward such that the jaw member 106 pivots about the intermediate member 126 to move the lower portion of the jaw member 106 toward jaw member 104. Alternatively, the construction worker can release the lever 108 and allow the spring 116 to move the jaw member 106 into the closed position. In the closed position, the spring 116 applies a sufficient amount of force to the jaw member 106 such that the clamp assembly 122 firmly engages and grips the framing member S to keep the alignment tool 110 in place.

Referring to FIG. 7, in operation, the alignment tool 110 grips a reference framing member S with clamp assembly 122 to properly position, align, and straighten a loose framing member S, that engages arm 124, within a building frame. In use, the construction worker operates the lever 108 of the alignment tool 110 to open the clamp assembly 122 and insert the reference framing member S therein. The clamp assembly 122 is then closed such that the jaw members 104, 106 engage opposite sides of the reference framing member S positioned there-between. As mentioned above, the spring 116 provides a sufficient force to bias the clamp assembly 122 in the closed position such that alignment device 110 is firmly held in place when the clamp assembly grips the reference framing member S. Once the alignment device 110 is mounted on the reference framing member S, the construction worker can then move a loose framing member (specifically, the side thereof) into engagement with the arm 124. When the loose framing member engages the arm 124 (FIG. 6), the loose framing member S is in position relative to the reference framing member such that the loose framing member is positioned and aligned in the building frame. In particular, the loose framing member S is generally parallel to the reference framing member, is spaced apart from the reference framing member by the desired spacing (e.g., 16 inches on center), and is generally squared up (e.g. perpendicular) with the building frame header and footer. Once the loose framing member is in position, the construction worker can fix the loose framing member to the building frame and then move the alignment tool 110 to position the next successive framing member. This process repeats until the building frame is fully assembled.

In view of the above, it will be seen that the several features of the invention are achieved and other advantageous results obtained.

Modifications and variations of the disclosed embodiments are possible without departing from the scope of the invention as described here and in the claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An alignment tool for use in building frame construction to position adjacent first and second framing members, the alignment tool comprising
a first clamp assembly configured to releasably grip the first framing member; and
a second clamp assembly connected to and spaced apart from the first clamp assembly, the second clamp assembly configured to releasably grip the second framing member;
wherein the first and second clamp assemblies are configured to align and position the first and second framing members with respect to one another when the first and second clamp assemblies grip the first and second framing members, respectively.

2. The alignment tool of claim 1, wherein the first and second clamp assemblies are configured to space apart the first and second framing members by a distance of 16 or 24 inches on center.

3. The alignment tool of claim 2, wherein the first and second clamp assemblies are configured to position the first and second framing members such that the first and second framing members are generally parallel to each other.

4. The alignment tool of claim 1, further comprising a prime mover operatively connected to the first and second clamp assemblies to move the first and second clamp assemblies between open and closed positions to releasably grip the first and second framing members, respectively, wherein the first and second clamp assemblies grip the first and second framing members, respectively, in the closed position and release the first and second framing members, respectively, in the open position.

5. The alignment tool of claim 4, wherein the prime mover is configured to move the first and second clamp assemblies between the open and closed positions at the same time.

6. The alignment tool of claim 4, wherein the prime mover includes a lever configured to be manually actuated to move the first and second clamp assemblies between the opened and closed positions.

7. The alignment tool of claim 1, wherein each of the first and second clamp assemblies include a first jaw member and a second jaw member, the first and second clamp assemblies configured to releasably grip the first and second framing members, respectively, between the first and second jaw members of the respective first and second clamp assemblies.

8. The alignment tool of claim 7, further comprising a prime mover operatively connected to one of the first and second jaw members of each of the first and second clamp assemblies to move the respective jaw members to releasably grip the first and second framing members.

9. The alignment tool of claim 7, wherein the prime mover is configured to move said one of the first and second jaw member of each of the first and second clamp assemblies at the same time.

10. The alignment tool of claim 7, wherein the first jaw members of the first and second clamp assemblies are fixed together and the second jaw members of the first and second clamp assemblies are fixed together.

11. The alignment tool of claim 7, further comprising first and second brackets coupled to one another and defining the first and second clamp assemblies, the first bracket including the first jaw members of the first and second clamp assemblies and the second bracket including the second jaw members of the first and second clamp assemblies.

12. The alignment tool of claim 11, wherein the first and second brackets are movable with respect to one another.

13. The alignment tool of claim 12, wherein the first and second brackets are longitudinally movable with respect to one another.

14. The alignment tool of claim 12, further comprising a prime mover operatively connected to one of the first and second brackets to move said one of the first and second brackets relative to the other bracket to move the first and second jaw members of the first and second clamp assemblies relative to one another to releasably grip the first and second framing members.

15. The alignment tool of claim 1, wherein the alignment tool is made of one or more materials selected from a group including high strength steel, molecular plastics, carbon fiber, and glass re-enforced plastic.

16. A method of positioning adjacent first and second framing members in building frame construction with respect to one another, the method comprising:
gripping the first framing member with a first clamp assembly of an alignment tool; and
gripping the second framing member with a second clamp assembly of the alignment tool,
wherein the first and second framing members are positioned with respect to one another when the first clamp assembly grips the first framing member and the second clamp assembly grips the second framing member.

17. The method of claim 16, wherein gripping the second framing member is simultaneous with gripping the first framing member.

18. The method of claim 16, wherein gripping the second framing member further includes moving the second framing member relative to the first framing member to position the first and second framing members relative to one another.

19. The method of claim 16, further comprising positioning, before gripping the first and second framing members, the alignment tool with respect to the first and second framing members such that the first framing member is received by the first clamp assembly and the second framing member is received by the second clamp assembly.

20. An alignment tool for use in building frame construction to position adjacent first and second framing members, the alignment tool comprising:
a rigid elongate body having opposite first and second ends;
an arm connected to the rigid elongate body adjacent the first end of the rigid elongate body, the arm configured to engage an outer side of the first framing member; and
a clamp assembly connected to the rigid elongate body adjacent the second end of the rigid elongate body, the clamp assembly having a first jaw member and a second jaw member, the clamp assembly configured to releasably grip the second framing member between the first and second jaw members,
wherein the arm and the clamp assembly are configured to align and position the first and second framing members with respect to one another when the arm engages the outer side of the first framing member and the clamp assembly grips the second framing member.
